(19) United States
(12) Patent Application Publication
(10) Pub. No.: US 2009/0085985 A1
(43) Pub. Date: Apr. 2, 2009

(54) LIQUID JET HEAD, METHOD FOR MANUFACTURING THE LIQUID JET HEAD, AND LIQUID JET APPARATUS

(75) Inventor: Akira Matsuzawa, Shiojiri-shi (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION, Tokyo (JP)

(21) Appl. No.: 12/198,620

(22) Filed: Aug. 26, 2008

(30) Foreign Application Priority Data
Aug. 27, 2007 (JP) 2007-220321
Aug. 20, 2008 (JP) 2008-212015

(51) Int. Cl. B41J 2/045

(52) U.S. Cl. 347/70; 216/27

(57) ABSTRACT

A liquid jet head includes: a nozzle plate provided with a nozzle orifice for jetting a liquid; a passage-forming substrate provided with a pressure generating chamber communicating with the nozzle orifice and bonded to the nozzle plate with an adhesive agent; and a pressure generator that vibrates a vibration plate, the pressure generator disposed in a region opposite to the pressure generating chamber with the vibration plate interposed in between. The passage-forming substrate is provided with a concave portion formed in a joint surface to the nozzle plate. The concave portion has a wall surface inclined from a side adjacent to the nozzle plate to an inside of the concave portion. An angle between the joint surface and the inclined wall surface of the concave portion is smaller than an angle between the joint surface and a wall surface of the pressure generating chamber in a region contacting the joint surface. The inclined wall surface of the concave portion is provided with a plurality of protrusions.

The entire disclosures of Japanese Patent Applications Nos. 2007-220321 filed Aug. 27, 2007 and 2008-212015 filed Aug. 20, 2008 are expressly incorporated by reference herein.

### BACKGROUND

1. Technical Field

The present invention relates to a liquid jet head to jet a liquid, a method for manufacturing the liquid jet head, and a liquid jet apparatus. More specifically, the invention relates to an inkjet recording head to eject ink as a liquid, a method for manufacturing the inkjet recording head and an inkjet recording apparatus.

2. Description of Related Art

In general, as inkjet recording heads being liquid jet heads used in printers, fax machines, copiers and the like, various types of heads according to the mechanism for ejecting ink droplets have been heretofore known. For example, in a type of such inkjet recording heads, part of a pressure generating chamber that communicates with a nozzle orifice is formed of a vibration plate. The recording head causes a pressure generator such as a piezoelectric element to deform this vibration plate so as to expand or contract a volume inside the pressure generating chamber. Thereby, the recording head ejects ink droplets from the nozzle orifice. Meanwhile, another type of such inkjet recording heads deforms the vibration plate by using an electrostatic force so as to change the volume of the pressure generating chamber, and thereby, the recording head ejects ink droplets from the nozzle orifice.

Meanwhile, such an inkjet recording head generally has a structure in which a nozzle plate is bonded to a passage-forming substrate with an adhesive agent. In the nozzle plate, multiple nozzle orifices for ejecting ink droplets are drilled, while the passage-forming substrate is provided with pressure generating chambers. For this reason, if the pressure generating chambers are densely arranged in the passage-forming substrate, the adhesion area between the nozzle plate and the passage-forming substrate is reduced so that an excess adhesive agent flows into the pressure generating chambers too much. This causes a problem that the adhesive agent that flows into the pressure generating chambers adheres to the vibration plate and leads to decrease in an amount of displacement of the vibration plate.

In order to prevent the adhesive agent from flowing into the pressure generating chamber, a type of such inkjet recording heads reduces the flow of the adhesive agent into the pressure generating chambers as follows, for example. Specifically, the inkjet recording head is provided with dummy pressure chambers on both ends of the line of pressure chambers, and provided with multiple adhesive escape grooves each formed of an independent concave portion outside these dummy pressure chambers. Thereby, the inkjet recording head causes the adhesive agent to flow into these dummy pressure chambers and escape grooves (see claims and FIG. 1 of JP-A-11-157063, claims and FIG. 7 of JP-A-7-125198, and claims and FIG. 1 of JP-A-2006-281603, for example).

Although it is possible to reduce the amount of the adhesive agent flowing into the pressure generating chambers to some extent by providing the dummy pressure chambers and the escape grooves as disclosed in JP-A-11-157063, JP-A-7-125198 and JP-A-2006-281603, there is a demand for further reducing the amount of the adhesive agent flowing into the pressure generating chambers. Note that such a problem exists not only in the inkjet recording heads but also in other liquid jet heads.

### SUMMARY

An advantage of some aspects of the present invention is to provide a liquid jet head capable of preventing a flow of an adhesive agent into a pressure generating chamber and thereby stabling an amount of displacement of a vibration plate; a method for manufacturing the liquid jet head; and a liquid jet apparatus.

A liquid jet head according to an aspect of the invention for solving the problem is characterized by including a nozzle plate provided with a nozzle orifice for jetting a liquid; a passage-forming substrate provided with a pressure generating chamber communicating with the nozzle orifice and bonded to the nozzle plate with an adhesive agent; and a pressure generator that vibrates a vibration plate, the pressure generator disposed in a region opposite to the pressure generating chamber with the vibration plate interposed in between. Here, the liquid jet head is characterized in that the passage-forming substrate is provided with a concave portion formed in a joint surface to the nozzle plate, the concave portion has a wall surface inclined from a side adjacent to the nozzle plate to the inside of the concave portion, an angle between the joint surface and the inclined wall surface of the concave portion is smaller than an angle between the joint surface and a wall surface of the pressure generating chamber in a region contacting the joint surface, and the inclined wall surface of the concave portion is provided with a plurality of protrusions. In this aspect, there is provided the concave portion including the wall surface defined as the inclined wall surface having the smaller angle relative to the joint surface than the wall surface of the pressure generating chamber in the region contacting the joint surface. Moreover, the protrusions are formed on the inclined wall surface of the concave potion. Accordingly, the excess adhesive agent is guided by the protrusions and flows into the concave portion more likely than to the pressure generating chamber, when the nozzle plate is bonded to the passage-forming substrate by using the adhesive agent. Therefore, the flow of the adhesive agent into the pressure generating chamber is prevented and, therefore the liquid jet head can be provided which has stable displacement of the vibration plate without adhesion of the adhesive agent to the vibration plate.

Meanwhile, the passage-forming substrate may be made of a silicon substrate with a surface having a crystal plane orientation of a (110) plane, the inclined wall surface of the concave portion may have a crystal plane orientation of a (111) plane, and the region, contacting the joint surface, of the wall surface of the pressure generating chamber may be substantially perpendicular to the joint surface. In this way, there is provided the liquid jetting head with the concave portion having the inclined wall surface, which is easily formed by anisotropic etching using KOH or the like.

Moreover, it is preferable that the passage-forming substrate be provided with a plurality of aforementioned pressure generating chambers defined by compartment walls formed therein, and a plurality of liquid supply paths defined by extending the compartment walls at one end, in a longitudinal direction, of the pressure generating chambers, each liquid supply path having a smaller width than a shorter-side width of each pressure generating chamber. It is also preferable that the concave portion be provided in the compartment wall between each two adjacent liquid supply paths. In this way, the concave portion is formed in the compartment wall between the liquid supply paths which has the narrower width than the width in the lateral direction of the pressure generating chamber, i.e. in a region of the compartment wall having a relatively large area. Accordingly, rigidity of the compartment wall is not lost.

Then, it is preferable that the protrusions protrude by 10 nm to 200 nm from the inclined wall surface of the concave portion. In this way, providing the relatively high protrusions ranging from 10 to 200 nm on the inclined surface tends to cause the excess adhesive agent to flow into the concave portion rather than into the pressure generating chamber when the nozzle plate is bonded to the passage-forming substrate with the adhesive agent. Accordingly, the flow of the adhesive agent into the pressure generating chamber is prevented and, therefore the liquid jet head can be provided which has stable displacement of the vibration plate without adhesion of the adhesive agent to the vibration plate.

Moreover, another aspect of the invention provides a liquid jet apparatus characterized by including the above-described liquid jet head. According to this aspect, it is possible to realize the liquid jet apparatus having excellent reliability and durability, since the liquid jet head having a stable amount of displacement of the vibration plate is included therein.

A method for manufacturing a liquid jet head of the invention is a method for manufacturing a liquid jet head including: a nozzle plate having a nozzle orifice for jetting a liquid; a passage-forming substrate provided with a pressure generating chamber communicating with the nozzle orifice and bonded to the nozzle plate with an adhesive agent; and a pressure generator that vibrates a vibration plate, the pressure generator disposed in a region opposite to the pressure generating chamber with the vibration plate interposed in between. The method is characterized by including forming a concave portion in a joint surface, to the nozzle plate, of the passage-forming substrate, the concave portion having a wall surface inclined from a side adjacent to the nozzle plate to the inside of the concave portion, an angle between the joint surface and the inclined wall surface of the concave portion being smaller than an angle between the joint surface and a wall surface of the pressure generating chamber in a region contacting the joint surface, the inclined wall surface of the concave portion provided with a plurality of protrusions; and thereafter bonding the nozzle plate to the passage-forming substrate with the adhesive agent. In this aspect, there is provided the concave portion including the wall surface defined as the inclined wall surface having the smaller angle relative to the joint surface than the wall surface of the pressure generating chamber in the region contacting the joint surface, and the protrusions are formed on the inclined wall surface. Thereafter, the nozzle plate is bonded to the passage-forming substrate by use of the adhesive agent. Accordingly, the excess adhesive agent is guided by the protrusions and tends to flow into the concave portion rather than into the pressure generating chamber. Therefore, the flow of the adhesive agent into the pressure generating chamber is prevented and, therefore the liquid jet head can be manufactured which has stable displacement of the vibration plate without adhesion of the adhesive agent to the vibration plate.

Meanwhile, the concave portion maybe formed by etching the passage-forming substrate by use of an etchant containing iron, and the protrusions may be formed by attaching iron to the inclined wall surface of the concave portion at the time of etching. In this way, it is possible to provide the protrusions in the etching process, and thereby to easily manufacture the liquid jet head having the stable displacement of the vibration plate without adhesion of the adhesive agent to the vibration plate because the adhesive agent is prevented from flowing into the pressure generating chamber. Moreover, by allowing the etchant to contain iron, it is possible to improve stability of etching.

Moreover, the protrusions formed of the iron and a protective film may be formed by forming the protective film made of tantalum oxide on the wall surfaces of the pressure generating chamber and the concave portion after attaching the iron to the inclined wall surface of the concave portion. In this way, the robust protrusions covered with the protective film can be formed easily.

### BRIEF DESCRIPTION OF THE DRAWINGS

FIG. 1 shows an exploded perspective view of a recording head according to Embodiment 1.

FIG. 2A shows a plan view of the recording head according to Embodiment 1 and FIG. 2B shows a cross-sectional view of the recording head according to Embodiment 1.

FIG. 3A shows a cross-sectional view of the recording head according to Embodiment 1 and FIG. 3B shows an enlarged cross-sectional view of a principal part of the recording head according to Embodiment 1.

FIG. 4 shows an enlarged plan view of a principal part of a passage-forming substrate according to Embodiment 1.

FIGS. 5A to 5C show cross-sectional views illustrating a method for manufacturing the recording head according to Embodiment 1.

FIGS. 6A to 6C show cross-sectional views illustrating the method for manufacturing the recording head according to Embodiment 1.

FIGS. 7A and 7B show cross-sectional views illustrating the method for manufacturing the recording head according to Embodiment 1.

FIGS. 8A and 8B show cross-sectional views illustrating the method for manufacturing the recording head according to Embodiment 1.

FIGS. 9A to 9C show cross-sectional views illustrating the method for manufacturing the recording head according to Embodiment 1.

FIGS. 10A and 10B show cross-sectional views illustrating the method for manufacturing the recording head according to Embodiment 1.

FIG. 11 shows a cross-sectional view illustrating the method for manufacturing the recording head according to Embodiment 1.

FIG. 12 shows a cross-sectional view illustrating the method for manufacturing the recording head according to Embodiment 1.

FIG. 13 shows a schematic diagram illustrating an example of an inkjet recording apparatus according to an embodiment.

### DESCRIPTION OF EXEMPLARY EMBODIMENTS

The present invention will be described below in detail based on an embodiment.

### Embodiment 1

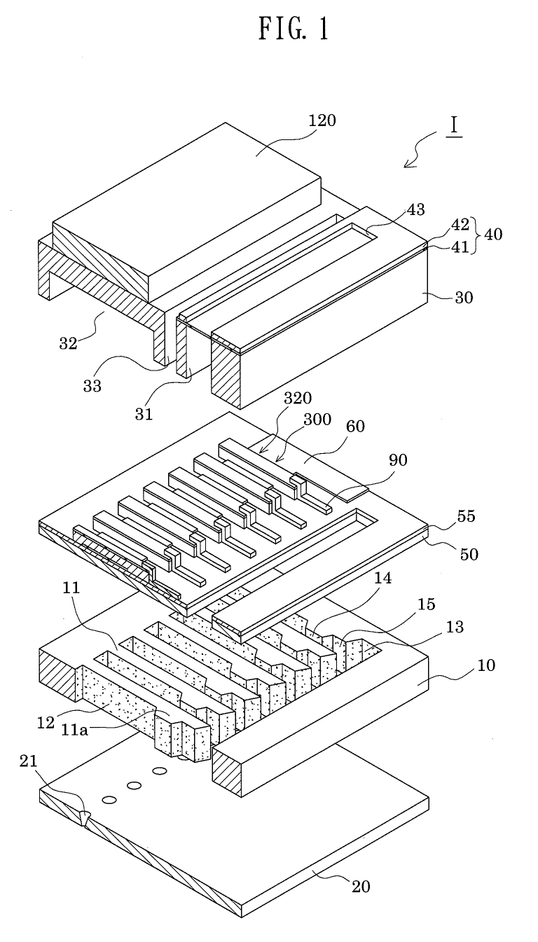

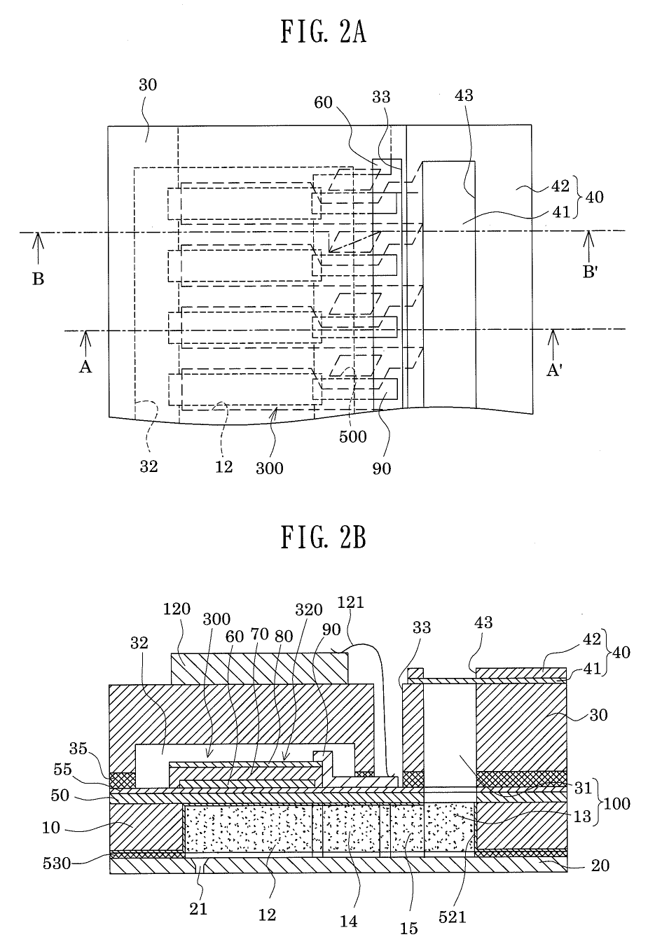

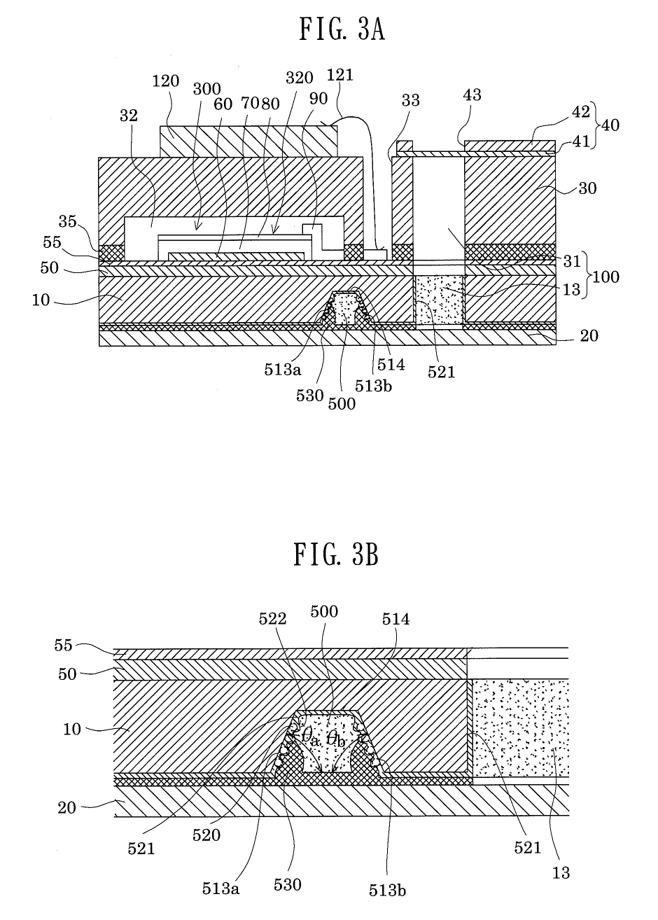

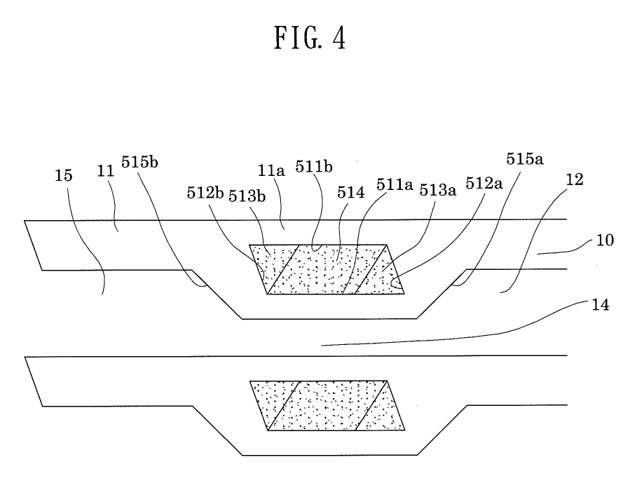

FIG. 1 is an exploded perspective view of an inkjet recording head I which is an example of a liquid jet head according to Embodiment 1 of the invention. FIG. 2A is a plan view of FIG. 1 and FIG. 2A is a cross-sectional view taken along the A-A′ line of FIG. 2A. Meanwhile, FIG. 3A is a cross-sectional view taken along the B-B′ line of FIG. 2A and FIG. 3B is an enlarged cross-sectional view of a principal part of FIG. 3A. FIG. 4 is an enlarged plan view of a principal part of a passage-forming substrate viewed from a nozzle plate side.

As shown in the drawings, a passage-forming substrate 10 is made of a single crystal silicon substrate having a crystal plane orientation of a (110) plane in this embodiment, and an elastic film 50 made of silicon dioxide and having a thickness of 0.5 to 2 μm is formed in advance by thermal oxidation on one of surfaces thereof.

Multiple pressure generating chambers 12 defined by multiple compartment walls 11 are arranged in parallel in a width direction (a lateral direction) thereof by performing anisotropic etching from the other surface side.

Meanwhile, ink supply paths 14 being liquid supply paths and communicating paths 15 are defined by the compartment walls 11 on one end side in a longitudinal direction of the pressure generating chambers 12 in the passage-forming substrate 10. Moreover, a communicating portion 13 that becomes part of a reservoir 100 serving as a common ink chamber (a liquid chamber) to the pressure generating chambers 12 is formed on one end of communicating paths 15 so as to communicate with a reservoir portion 31 of a protection plate 30 to be described later. Specifically, in this embodiment, the passage-forming substrate 10 is provided with the pressure generating chambers 12, the communicating portion 13, the ink supply paths 14, and the communicating paths 15, as a liquid passage including the pressure generating chambers 12. Moreover, the pressure generating chambers 12, the communicating portion 13, the ink supply paths 14, and the communicating paths 15 are provided with a protective film 521 having ink resistance (liquid resistance) which is made of tantalum oxide or the like. Further, the ink supply path 14 communicates with one end side in the longitudinal direction of the pressure generating chamber 12 and has a smaller width than a width in the lateral direction of the pressure generating chamber 12. Specifically, the ink supply path 14 is formed by narrowing a passage on the pressure generating chamber 12 side in the width direction of the passage formed between the reservoir 100 and the pressure generating chamber 12. Meanwhile, each communicating path 15 is formed in such a manner that the compartment walls 11 on both sides in the width direction of the pressure generating chamber 12 is extended toward the communicating portion 13 to define a space between the ink supply path 14 and the communicating portion 13. The communicating path 15 is formed into a larger width than the width of the ink supply path 14. In this embodiment, the communicating paths 15 are formed in the same width as the width of the pressure generating chambers 12. Note that wall surfaces of the pressure generating chambers 12, the communicating portions 13, the ink supply paths 14, and the communicating paths 15 are perpendicular surfaces to the surface (the (110) plane) of the passage-forming substrate 10, and that wall surfaces along the longitudinal direction of the pressure generating chambers 12 are formed by first (111) planes which are perpendicular to the (110) plane.

Meanwhile, in this embodiment, a compartment wall 11a for defining the ink supply path 14, i.e. a larger-width region of the compartment wall 11 for defining the pressure generating chambers 12, the ink supply paths 14, and the communicating paths 15 is provided with a concave portion 500 on a joint surface with a nozzle plate 20 to be described later. This concave portion 500 has an opening portion in a shape of a parallelogram, and consists of a pair of wall surfaces 511a and 511b defined by first (111) planes perpendicular to the (110) plane; a pair of wall surfaces 512a and 512b defined by second (111) planes which form an angle of 70.53° relative to the first (111) planes and are perpendicular to the (110) plane; a pair of wall surfaces 513a and 513b defined by (111) planes which contact a joint surface between the passage-forming substrate 10 and the nozzle plate 20 and form an angle of 54.73° relative to the first (111) planes; and a bottom surface 514 defined by the (110) plane. Note that the wall surface 513a is located in the vicinity of the pressure generating chamber 12.

Here, an angle θa of the inclined wall surface 513a of the concave portion 500 relative to the joint surface is acute, while an angle of a wall surface 515a of the pressure generating chamber 12 opposite to this wall surface 513a is equal to 90° as described previously. Accordingly, the angle θa of the inclined wall surface 513a of the concave portion relative to the joint surface is configured to be smaller than the angle of the wall surface 515a of the pressure generating chamber 12 relative to the joint surface.

Meanwhile, the entire surface of the inclined wall surface 513a of the concave portion 500 is provided with protrusions 522, which includes grains 520 of iron or the like and the protective film 521 made of tantalum oxide or the like formed thereon, and protrudes from the inclined wall surface 513a in amounts ranging from 10 nm to 200 nm.

Moreover, the nozzle plate 20 provided with nozzle orifices 21 drilled therein so as to communicate with vicinity of the end opposite to the ink supply paths 14 of the pressure generating chambers 12 is fixed to an opening surface side of the above-described passage-forming substrate 10 by use of an adhesive agent 530. Here, the nozzle plate 20 is made of a glass ceramic, a single crystal silicon substrate, stainless steel (SUS) or the like.

In this embodiment, when the passage- forming substrate 10 is bonded to the nozzle plate 20 by using the adhesive agent 530, the inclined wall surface 513a is provided at a smaller angle relative to the joint surface than the wall surface 515a of the pressure generating chamber 12 so that the unnecessary adhesive agent 530 tends to flow more onto the inclined wall surface 513a of the concave portion 500 than the wall surface 515a of the pressure generating chamber 12. Meanwhile, when the multiple protrusions 522 are provided on the inclined wall surface 513a of the concave portion 500, thin grooves are formed between the protrusions 522 whereby the adhesive agent 530 is guided into these thin grooves by way of a capillary phenomenon and the adhesive agent 530 tends to flow more on the inclined wall surface 513a of the concave portion 500 than the wall surface 515a of the pressure generating chamber 12. Therefore, by forming the concave portion 500 provided with the inclined surface (the wall surface 513a) having the protrusions 522 inside the compartment wall 11 that contacts the pressure generating chamber 12, there is provided a structure that the excess adhesive agent 530 flows more easily into the concave portion 500 than into the pressure generating chamber 12 when the nozzle plate 20 is bonded to the passage-forming substrate 10 by using the adhesive agent 530. Accordingly, the flow of the adhesive agent 530 into the pressure generating chamber 12 is prevented and there is provided the inkjet recording head I having stable displacement of the vibration plate without adhesion of the adhesive agent 530 to the vibration plate to be described later. Here, the wall surface 515a of the pressure generating chamber 12 only needs to have the angle in the region contacting the joint surface relative to the joint surface which is greater than the inclination of the inclined wall surface 513a of the concave portion 500. For example, concerning a region on an opposite side of the joint surface of the wall surface 515a of the pressure generating chamber 12 with the nozzle plate 20, i.e. the region contacting the protection plate 30 to be described later, the angle is not particularly limited because there is very little influence on the flow of the adhesive agent 530. Meanwhile, when the protrusions 522 are provided on the wall surface 515a of the pressure generating chamber 12, it is preferable to provide more protrusions on the inclined wall surface 513a of the concave portion 500 than on the wall surface 515a of the pressure generating chamber 12.

Here, in this embodiment, the wall surface 513b is also formed into the inclined surface that is inclined toward the inside of the concave portion 500. Accordingly, an angle θb of the inclined wall surface 513b relative to the joint surface is smaller than the angle (90°) between a wall surface 515b of the communicating path 15 and the joint surface. Therefore, it is possible to prevent a flow of the adhesive agent 530 into the communicating path 15 and also to prevent the adhesive agent 530 flowing into the communicating path 15 from adhering to the vibration plate. Hence the displacement of the vibration plate is more stabilized.

Meanwhile, as described previously, the elastic film 50 in a thickness of about 1.0 μm, for example, is formed on the surface of the passage-forming substrate 10 located on the opposite side of the nozzle plate 20. An insulation film 55 in a thickness of about 0.4 μm, for example, is formed on this elastic film 50. Moreover, on this insulation film 55, a lower electrode film 60 in a thickness of about 0.2 μm, for example, a piezoelectric layer 70 in a thickness of about 1.0 μm, for example, and an upper electrode film 80 in a thickness of about 0.05 μm, are laminated in processes to be described later to constitute a piezoelectric element 300. Here, the piezoelectric element 300 means a portion including the lower electrode film 60, the piezoelectric layer 70, and the upper electrode film 80. In general, one of the electrodes of the piezoelectric element 300 is defined as a common electrode, while the other electrode and the piezoelectric layer 70 are patterned for each of the pressure generating chambers 12 to configure the piezoelectric element 300. Thereafter, a portion formed of one of the electrodes and the piezoelectric layer 70 thus patterned to cause piezoelectric strain upon application of a voltage to the two electrodes is herein referred to as a piezoelectric active portion 320. In this embodiment, the lower electrode film 60 is defined as the common electrode of the piezoelectric element 300 while the upper electrode film 80 is defined as an individual electrode of the piezoelectric element 300. However, there is no problem if an inverted configuration is employed for convenience of a drive circuit or wiring. In either case, the piezoelectric active portion 320 is formed for each pressure generating chamber 12. Meanwhile, the piezoelectric element 300 and the vibration plate that causes displacement by a drive of the piezoelectric element 300 will be collectively referred to as an actuator device herein. Although the elastic film 50, the insulation film 55, and the lower electrode film 60 function as the vibration plate in the above-described example, it is also possible to leave only the lower electrode film 60 without providing the elastic film 50 or the insulation film 55 and therefore to use the lower electrode film 60 as the vibration plate. Moreover, in this embodiment, since the concave portion 500 having the predetermined inclined wall surface 513a is provided in the passage-forming substrate 10 as described previously, the adhesive agent 530 does not adhere to this vibration plate.

Meanwhile, lead electrodes 90 such as gold (Au) extending on the ink supply paths 14 side of the passage-forming substrate 10 are respectively connected to the upper electrode films 80 of the piezoelectric elements 300. Voltages are selectively applied to the piezoelectric elements 300 through these lead electrodes 90.

Moreover, the protection plate 30 provided with the reservoir portion 31 formed in the region opposite to the communicating portion 13 is bonded onto the passage-forming substrate 10 provided with the piezoelectric elements 300 by use of an adhesive agent 35. As described previously, this reservoir portion 31 communicates with the communicating portion 13 of the passage-forming substrate 10 and constitutes the reservoir 100 that functions as the common ink chamber to the pressure generating chambers 12.

Meanwhile, a piezoelectric element holding portion 32 having sufficient space enough so as not to hinder movement of the piezoelectric elements 300 is provided in a region of the protection plate 30 opposite to the piezoelectric elements 300. Here, the piezoelectric element holding portion 32 only needs to have the sufficient space enough so as not to hinder the movement of the piezoelectric elements 300, and the space maybe hermetically sealed or not hermetically sealed.

Further, a through hole 33 that penetrates the protection plate 30 in the thickness direction is provided in a region between the piezoelectric element holding portion 32 and the reservoir portion 31 of the protection plate 30, and part of the lower electrode film 60 and one of tip ends of the lead electrodes 90 are exposed inside this through hole 33.

Meanwhile, a drive circuit 120 for driving the piezoelectric elements 300 is mounted on the protection plate 30. For example, a circuit board, a semiconductor integrated circuit (IC), or the like is usable as the drive circuit 120. Moreover, the drive circuit 120 is electrically connected to the lead electrodes 90 via connection wirings 121 made of conductive wires such as bonding wires.

As for the protection plate 30, it is preferable to use a material having substantially the same thermal expansion coefficient as that of the passage-forming substrate 10 such as glass or ceramic material. In this embodiment, the protection plate 30 is formed by use of a single crystal silicon substrate having the plane orientation of (110) plane which is the same material as the passage-forming substrate 10.

Meanwhile, a compliance plate 40 including a sealing film 41 and a fixation plate 42 is bonded onto the protection plate 30. Here, the sealing film 41 is made of a low-rigidity material having flexibility (such as a polyphenylene sulfide (PPS) film having a thickness of 6 μm), and one surface of the reservoir portion 31 is sealed with this sealing film 41. Meanwhile, the fixation plate 42 is formed of a hard material such as metal (stainless steel (SUS) in a thickness of 30 μm, for example). A region of this fixation plate 42 opposite to the reservoir 100 is entirely removed in the thickness direction and is formed into an opening portion 43. Accordingly, the one surface of the reservoir 100 is sealed by only the sealing film 41 having flexibility.

In the above-described inkjet recording head of this embodiment, ink is taken from unillustrated external ink supplier and the inside ranging from the reservoir 100 to the nozzle orifices 21 is filled with the ink. Subsequently, a voltage is applied between the lower electrode film 60 and the upper electrode film 80 corresponding to each of the pressure generating chambers 12 in accordance with a recording signal from the drive circuit 120 so as to subject the elastic film 50, the insulation film 55, the lower electrode film 60, and the piezoelectric layer 70 to flexural deformation. The pressure inside the pressure generating chambers 12 is thereby increased so that ink droplets are ejected from the nozzle orifices 21.

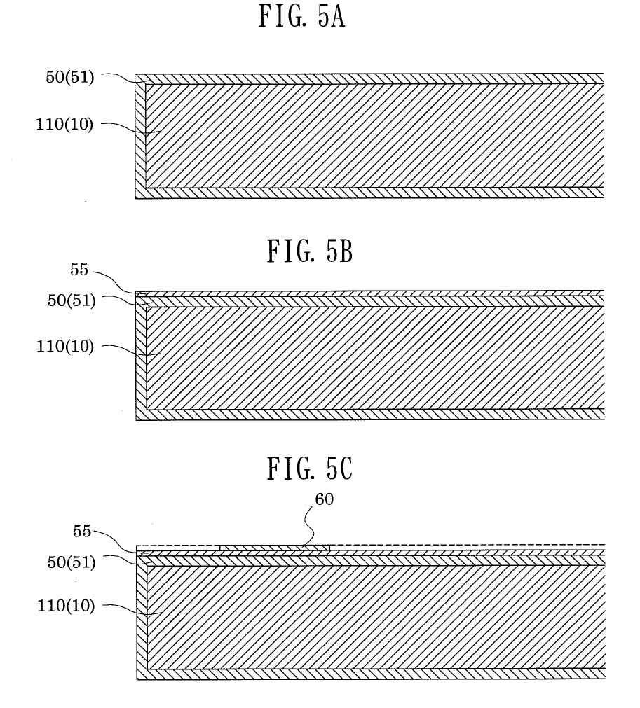

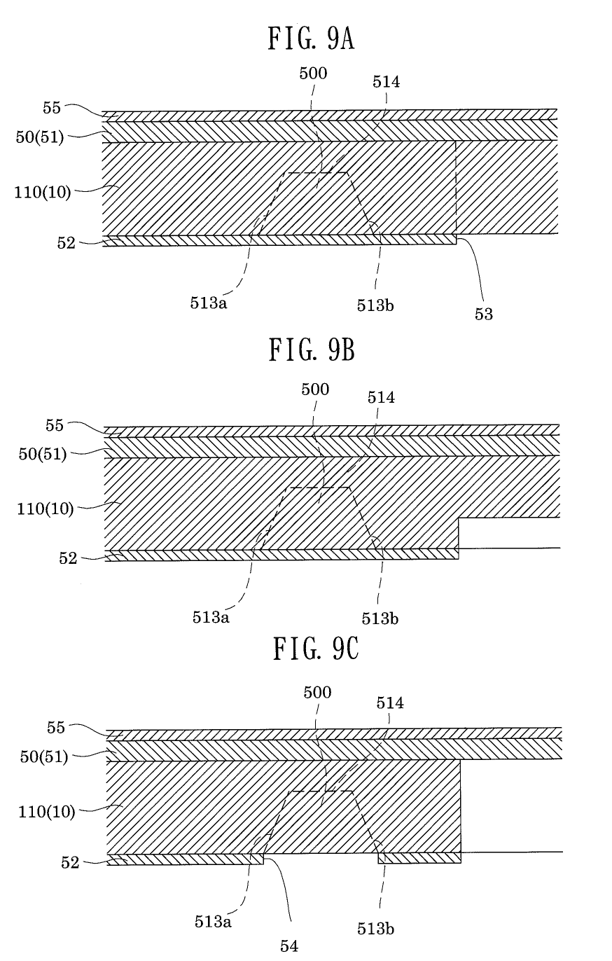

Here, an example of a method of manufacturing this inkjet recording head 1 will be described with reference to FIGS. 5 to 12. FIGS. 5 to 12 are cross-sectional views of the pressure generating chamber 12 taken in the longitudinal direction. FIGS. 9, 10, and 12 are enlarged cross-sectional views of the neighborhood of the concave portion and the ink supply path taken along the B-B′ line of FIG. 2A. First, as shown in FIG. 5A, a silicon dioxide film 51 constituting the elastic film 50 is formed on a surface of a passage-forming substrate wafer 110 which is a silicon wafer. Next, as shown in FIG. 5B, the insulation film 55 made of zirconium oxide is formed on the elastic film 50 (the silicon dioxide film 51).

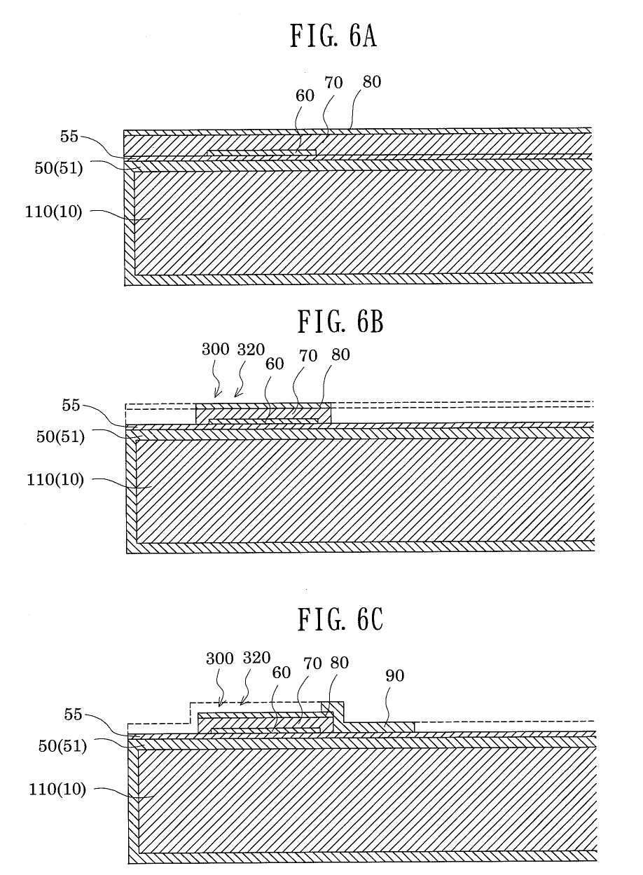

Next, the piezoelectric element 300 is formed on the insulation film 55. To be more precise, the lower electrode film 60 made of platinum or the like is first formed on the entire surface of the insulation film 55 and is patterned into a predetermined shape as shown in FIG. 5C. Next, as shown in FIG. 6A, the piezoelectric layer 70 made of lead zirconate titanate (PZT), for example, and the upper electrode film 60 made of metal such as platinum, for example, are sequentially laminated, and the piezoelectric element 300 is formed by simultaneously patterning these constituents as shown in FIG. 6B. Subsequently, as shown in FIG. 6C, the lead electrode 90 made of gold (Au) or the like, for example, is formed on the entire surface of the passage-forming substrate wafer 110 and is patterned for each of the piezoelectric elements 300. These are film forming processes. Here, in this embodiment, the piezoelectric layer 70 is formed by a so-called sol-gel method. According to the sol-gel method, a metal organic material is dissolved and dispersed in a solvent to obtain so-called sol, the thus-obtained sol gelates upon application and drying to form a piezoelectric precursor film, and then the piezoelectric precursor film is calcinated at a high temperature to obtain the piezoelectric layer 70 made of metal dioxide. Alternatively, without limitations to the sol-gel method, it is also possible to employ a metal-organic decomposition (MOD) method, a sputtering method, or the like.

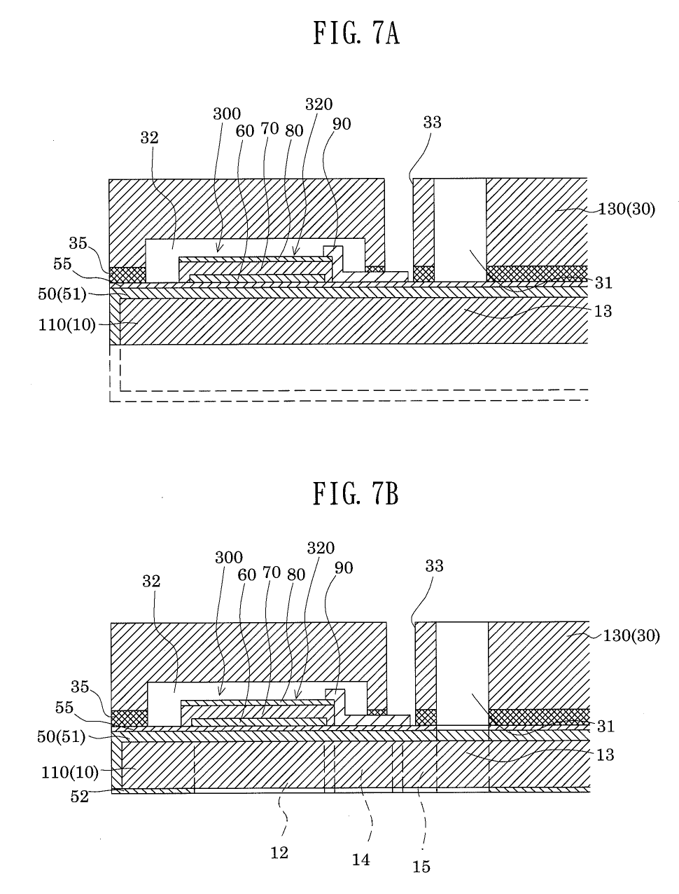

Thereafter, as shown in FIG. 7A, a protection plate wafer 130 which is a silicon wafer and will serve as the multiple protection plates 30 is bonded to the passage-forming substrate wafer 110 on the piezoelectric elements 300 side by use of the adhesive agent 35. Next, the passage-forming substrate wafer 110 is thinned down to a predetermined thickness.

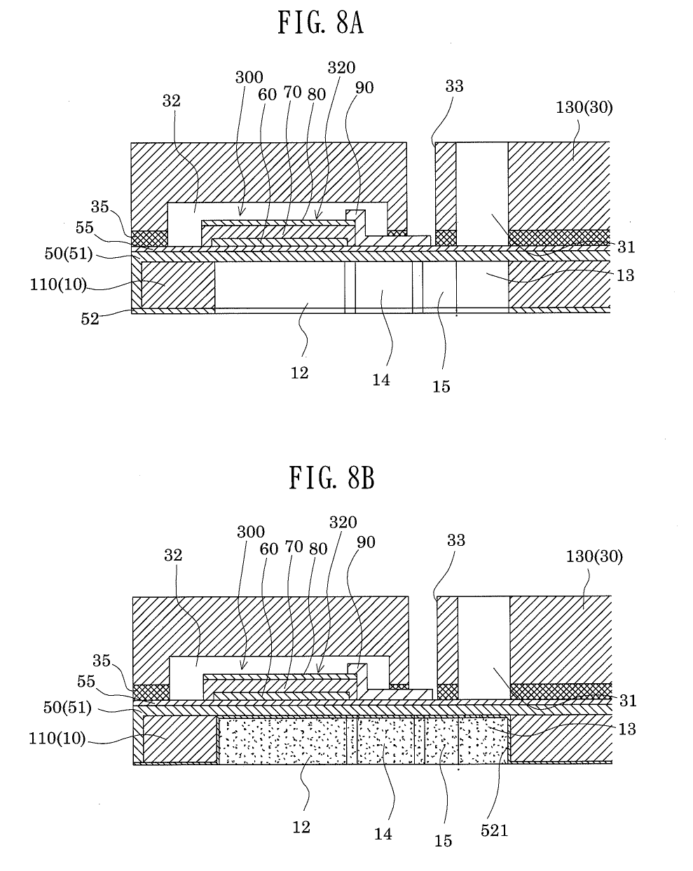

Thereafter, as shown in FIG. 7B, a mask film 52 is newly formed on the passage-forming substrate wafer 110 and is patterned into a predetermined shape. Then, as shown in FIG. 8A, the pressure generating chambers 12, the communicating portion 13, the ink supply paths 14, the communicating paths 15, the concave portions 500, and the like corresponding to the piezoelectric elements 300 are formed by performing anisotropic etching (wet etching) on the passage-forming substrate wafer 110 with the mask film 52 by use of an alkaline solution such as KOH. Thereafter, as shown in FIG. 8B, the protective film 521 made of tantalum oxide or the like is formed on the pressure generating chambers 12, the communicating portion 13, the ink supply paths 14, the communicating paths 15, and the concave portions 500.

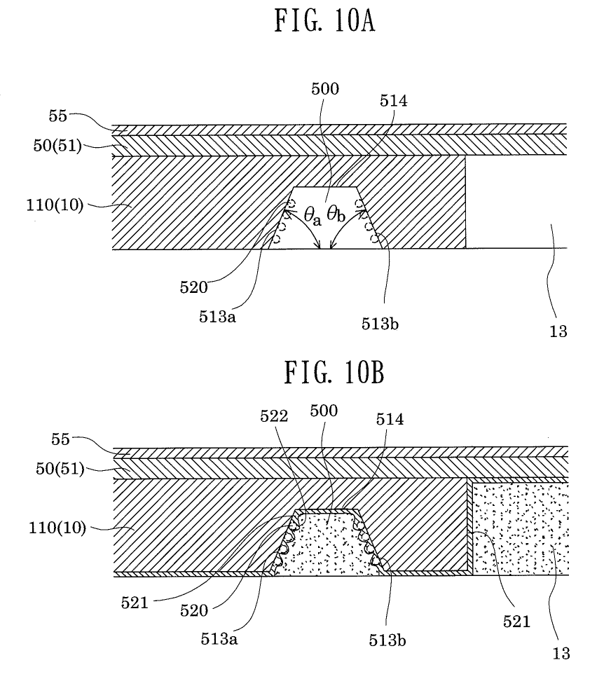

To be more precise, the mask film 52 is firstly formed on the passage-forming substrate wafer 110. Then as shown in FIG. 9 which are enlarged cross-sectional views of the neighborhood of the concave portion 500 and the ink supply path 14 taken along the B-B′ line of FIG. 2A, the passage-forming substrate wafer 110 is patterned so as to form an open portion 53 in a region of the mask film 52 corresponding to the pressure generating chamber 12, the communicating portion 13, the ink supply path 14, and the communicating path 15 (FIG. 9A). Then, etching is performed halfway in the thickness direction of the passage-forming substrate wafer 110 by use of the alkaline solution such as KOH (FIG. 9B). Thereafter, as shown in FIG. 9C, the opening portion 54 is formed on the mask film 52 in a region corresponding to the concave portion 500. Then, the concave portion 500 is formed by performing anisotropic etching (FIG. 10A). In this embodiment, by performing the anisotropic etching using the etchant made of a KOH solution containing iron, there is formed the concave portion 500 including the open portion in the shape of a parallelogram, the pair of wall surfaces 511a and 511b defined by the first (111) planes perpendicular to the (110) plane, the pair of wall surfaces 512a and 512b defined by the second (111) planes which form the angle of 70.53° relative to the first (111) planes and are perpendicular to the (110) plane, the pair of wall surfaces 513a and 513b defined by the (111) planes which contact the joint surface between the passage-forming substrate 10 and the nozzle plate 20 and form the angle of 54.73° relative to the first (111) planes, and the bottom surface 514 defined by the (110) plane. Meanwhile, iron grains contained in the etchant are attached, in the shapes of protrusions, to the wall surfaces 511a, 511b, 512a, 512b, 513a, and 513b of the concave portion 500 formed by the etching. In this embodiment, these iron grains 520 are left unremoved. Here, it is possible to attach more iron grains 520 to the inclined wall surfaces 513a and 513b as compared to the other wall surfaces of the concave portion 500.

Then, after removing the mask film 52, the protective film 521 made of the material having liquid resistance (ink resistance) such as an oxide or a nitride, which is made of tantalum oxide in this embodiment, is formed on the entire surfaces of the pressure generating chamber 12, the communicating portion 13, the ink supply path 14, the communicating path 15, and the concave portion 500 by a CVD method or the like as shown in FIG. 10B. Here, in this embodiment, the iron grains 520 are attached to the wall surfaces 511a, 511b, 512a, 512b, 513a, and 513b of the concave portions 500. Accordingly, the protrusions 522 consisting of the iron grains 520 and the protective film 521 are formed on the 511aand 511b, 512a and 512b, 513a and 513b provided with the protective film 521. Meanwhile, it is possible to attach more iron grains 520 onto the inclined surfaces, i.e. the wall surfaces 513a and 513b. Accordingly, the protrusions 522 consisting of the iron grains 520 and the protective film 521 can be increased as compared to the other wall surfaces.

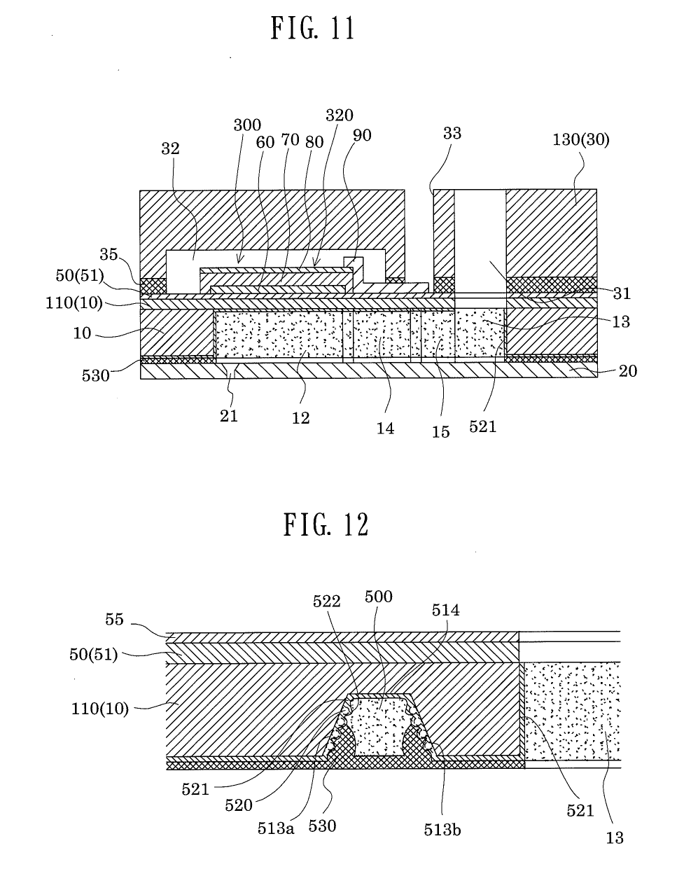

Thereafter, unnecessary portions of the passage-forming substrate wafer 110 and the protection plate wafer 130 are removed by cutting by means of dicing, for example. Then, as shown in FIG. 11, the nozzle plate 20 provided with the nozzle orifices 21 is bonded to the passage-forming substrate wafer 110 on the side opposite to the protection plate wafer 130 by use of the adhesive agent 530. Here, this embodiment includes the concave portion 500 having the inclined wall surfaces 513a and 513b provided with the protrusions 522 as described previously. Therefore, as shown in FIG. 12 which is the enlarged cross-sectional view of the neighborhood of the concave portion 500 and the ink supply path 14 taken along the B-B′ line of FIG. 2A, the excess adhesive agent 530 is guided to the protrusions 522 on the inclines wall surfaces 513a and 513b presumably due to the capillary phenomenon and flows easily into the concave portion 500. Therefore, the flow of the excess adhesive agent 530 into the pressure generating chamber 12 is prevented and adhesion of the adhesive agent to the vibration plate is eliminated. Accordingly, the inkjet recording head I with stable displacement can be formed. Here, it is possible to provide the inclined wall surfaces 513a and 513b of the concave portion 500 with the protrusions 522 made of iron or the like at the time of etching by appropriately adjusting, for example, etching conditions such as the composition of the etchant or etching time.

Then, the inkjet recording head 1 is formed by bonding the compliance plate 40 and the like to the protection plate wafer 130 and by dividing the passage-forming substrate wafer 110 and others into the passage-forming substrate 10 and others in a single chip size as shown in FIG. 1.

In this embodiment, the concave portion 500 having the opening portion in the parallelogram shape and with six wall surfaces is formed by subjecting the single crystal silicon substrate having the crystal plane orientation of the (110) plane to anisotropic etching. However, without limitations to this shape, the concave portion 500 only needs wall surfaces which contact the joint surface, are provided with the protrusions, and are inclined at a predetermined angle. Moreover, the concave portion 500 is formed by wet etching in this embodiment, however, may be formed by dry etching, for example. Meanwhile, the protrusions 522 are formed of the iron grains 520 and the protective film 521 in this embodiment, however, the material and shape of the protrusions 522 are not particularly limited. Moreover, the protrusions 522 are provided at the time of etching in this embodiment, however, the method of forming the protrusions is not particularly limited. For example, it is also possible to provide the protrusions by sputtering or the like. Further, the region to form the concave portion 500 is not particularly limited. However, it is preferable to provide the concave portion 500 in a wide region (the compartment wall 11a) as in this embodiment, because the adhesion area can be increased to have favorable adhesion strength. Although the concave portion 500 is formed inside the compartment wall 11 in this embodiment, the region to provide the concave portion 500 is not limited to the inside of the compartment wall 11. For example, the concave portion 500 may be formed in the passage-forming substrate 10 on one end side opposite to the ink supply path 14 of the pressure generating chamber 12.

### Another Embodiment

The embodiment of the present invention has been described above. However, it is needless to say that the invention is not limited to the above-described embodiment. For example, the foregoing embodiment has been described by use of the actuator device that includes the thin-film type piezoelectric element 300 as a pressure generator that generates a pressure change in the pressure generating chamber 12. However, the invention is not particularly limited to the foregoing. For example, it is possible to use an actuator device of a thick-film type formed by a method of attaching a green sheet or the like, or an actuator device of a vertical vibration type configured to laminate piezoelectric materials and electrode forming materials alternately to achieve expansion and contraction in an axial direction, for example. Meanwhile, as the pressure generator, a so-called electrostatic actuator may be used, which is configured to generate static electricity between a vibration plate and an electrode, to deform the vibration plate by an electrostatic force, and thereby to eject ink droplets from a nozzle orifice.

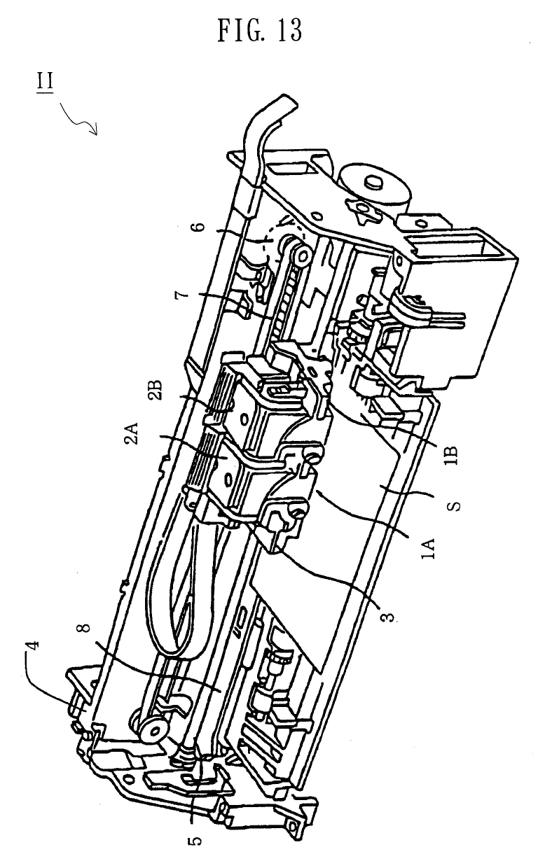

Meanwhile, this inkjet recording head constitutes part of a recording head unit that includes an ink flow passage communicating with an ink cartridge or the like and is mounted on an inkjet recording apparatus. FIG. 13 is a schematic diagram showing an example of the inkjet recording apparatus. As shown in FIG. 13, cartridges 2A and 2B constituting ink supplier are detachably provided on recording head units 1A and 1B that include inkjet recording heads. A carriage 3 with these recording head units 1A and 1B mounted is provided on a carriage shaft 5 fitted to an apparatus body 4, so as to be freely movable in a direction of the shaft. For example, these recording head units 1A and 1B are configured to eject a black ink composition and color ink compositions, respectively. Moreover, a drive force of a drive motor 6 is transmitted to the carriage 3 through unillustrated multiple gears and a timing belt 7, and thereby the carriage 3 with the recording head units 1A and 1B mounted is moved along the carriage shaft 5. Meanwhile, the apparatus body 4 is provided with a platen 8 along the carriage shaft 5, and a printing sheet S as a recording medium such as paper fed by an unillustrated paper feed roller, is transferred on the platen 8.

Meanwhile, the embodiment has been described above concerning the inkjet recording head as an example of the liquid jet head. However, the invention is targeted for a wide range of liquid jet heads at large, and is by all means applicable to liquid jet heads for jetting liquids other than ink. For example, other liquid jet heads may include various recording heads used in image recording apparatuses such as printers, color material jet heads used for manufacturing color filters of liquid crystal displays and the like, electrode material jet heads used for forming electrodes of organic EL displays, field emission displays (FEDs), and the like, living organic material jet heads used for manufacturing biochips, and so forth.

1. A liquid jet head comprising:
a nozzle plate provided with a nozzle orifice for jetting a liquid;
a passage-forming substrate provided with a pressure generating chamber communicating with the nozzle orifice and bonded to the nozzle plate with an adhesive agent; and
a pressure generator that vibrates a vibration plate, the pressure generator disposed in a region opposite to the pressure generating chamber with the vibration plate interposed in between, wherein
the passage-forming substrate is provided with a concave portion formed in a joint surface to the nozzle plate,
the concave portion has a wall surface inclined from a side adjacent to the nozzle plate to an inside of the concave portion,
an angle between the joint surface and the inclined wall surface of the concave portion is smaller than an angle between the joint surface and a wall surface of the pressure generating chamber in a region contacting the joint surface, and
the inclined wall surface of the concave portion is provided with a plurality of protrusions.

2. The liquid jet head according to claim 1, wherein the passage-forming substrate is made of a silicon substrate with a surface having a crystal plane orientation of a (110) plane,
the inclined wall surface of the concave portion has a crystal plane orientation of a (111) plane, and
the region, contacting the joint surface, of the wall surface of the pressure generating chamber is substantially perpendicular to the joint surface.

3. The liquid jet head according to claim 1, wherein
the passage-forming substrate is provided with
a plurality of aforementioned pressure generating chambers defined by compartment walls formed therein, and
a plurality of liquid supply paths defined by extending the compartment walls at one end, in a longitudinal direction, of the pressure generating chambers, each liquid supply path having a smaller width than a shorter-side width of each pressure generating chamber, and
the concave portion is provided in the compartment wall between each adjacent two liquid supply paths.

4. The liquid jet head according to claim 1, wherein the protrusions protrude by 10 nm to 200 nm from the inclined wall surface of the concave portion.

5. A liquid jet apparatus comprising the liquid jet head according to claim 1.

6. A method for manufacturing a liquid jet head including: a nozzle plate having a nozzle orifice for jetting a liquid; a passage-forming substrate provided with a pressure generating chamber communicating with the nozzle orifice and bonded to the nozzle plate with an adhesive agent; and a pressure generator that vibrates a vibration plate, the pressure generator disposed in a region opposite to the pressure generating chamber with the vibration plate interposed in between, the method comprising
forming a concave portion in a joint surface, to the nozzle plate, of the passage-forming substrate,
the concave portion having a wall surface inclined from a side adjacent to the nozzle plate to the inside of the concave portion,
an angle between the joint surface and the inclined wall surface of the concave portion being smaller than an angle between the joint surface and a wall surface of the pressure generating chamber in a region contacting the joint surface,
the inclined wall surface of the concave portion provided with a plurality of protrusions; and
thereafter bonding the nozzle plate to the passage-forming substrate with the adhesive agent.

7. The method for manufacturing a liquid jet head according to claim 6, wherein
the concave portion is formed by etching the passage-forming substrate by use of an etchant containing iron, and
the protrusions are formed by attaching iron to the inclined wall surface of the concave portion at the time of etching.

8. The method for manufacturing a liquid jet head according to claim 7, wherein
the protrusions formed of the iron and a protective film are formed by forming the protective film made of tantalum oxide on the wall surfaces of the pressure generating chamber and the concave portion after attaching the iron to the inclined wall surface of the concave portion.
